(19) United States
(12) Patent Application Publication
(10) Pub. No.: US 2010/0092727 A1
(43) Pub. Date: Apr. 15, 2010

(54) NANOIMPRINTING MOLD AND MAGNETIC RECORDING MEDIA MANUFACTURED USING SAME

(75) Inventor: Shinji UCHIDA, Matsumoto City (JP)

Correspondence Address: ROSSI, KIMMS & McDOWELL LLP., 20609 Gordon Park Square, Suite 150, Ashburn, VA, 20147, US

(73) Assignee: FUJI ELECTRIC DEVICE TECHNOLOGY CO., LTD., Tokyo (JP)

(21) Appl. No.: 12/545,616

(22) Filed: Aug. 21, 2009

(30) Foreign Application Priority Data
Aug. 21, 2008 (JP) 2008-213003

(51) Int. Cl. G11B 5/738; D06N 7/04; B32B 27/06; B29B 11/06

(52) U.S. Cl. 428/142; 156/242; 156/501; 427/133

(57) ABSTRACT

A mold for nanoimprinting is provided which enables excellent S/N ratios in magnetic recording media after pattern transfer. The mold includes: a base material; an intermediate layer disposed adjacent to the base material; and a pattern formation layer disposed adjacent to the intermediate layer and having a fine uneven pattern in the surface. The intermediate layer comprises an adhesive containing a silicone resin with ultraviolet ray transmission properties, the elastic modulus thereof is smaller than the elastic modulus of the base material, and moreover is smaller than the elastic modulus of the pattern formation layer.

### BACKGROUND OF THE INVENTION

The invention relates to a mold for nanoimprinting. More specifically, a nanoimprinting mold of this invention is a mold which is suitable for manufacture of magnetic recording media exhibiting an excellent S/N ratio (Signal-to-Noise ratio). This invention also relates to magnetic recording media manufactured using such a mold.

In the fields of discrete track media and of semiconductor devices, resist layers formed on substrate surfaces which have ever-finer patterns are sought, accompanying continued rises in integration densities, defined as the number of constituent elements arranged on the substrate.

As methods of forming such a fine pattern in a resist layer, photolithography techniques have conventionally been used. In photolithography, after exposing the resist layer to light to form an exposure pattern, the resist layer is subjected to development processing to form a pattern in the resist on the substrate.

In order to form finer patterns in a resist layer by means of photolithography, the wavelength of the exposure light has been shortened. For example, it is known that in order to form a fine resist pattern with feature sizes of 100 nm or less, electron beam (EB) lithography has been used, employing as the exposure light an electron beam (EB) with shorter wavelength than the exposure light conventionally used. However, when using EB lithography, the equipment employed is expensive, and there are cases in which good throughput is not realized due to pattern drawing requiring long lengths of time. For these reasons, EB lithography is not easily applied to the efficient formation of fine patterns in resist layers, as for example in mass production.

Hence as a substitute method for EB lithography, which is moreover a separate method for efficiently forming fine patterns, nanoimprinting methods are widely used, and for example the following technologies have been disclosed.

In U.S. Pat. No. 5,772,905, a method is disclosed in which a mold, on which is formed an uneven pattern, is pressed against resist formed on the surface of a substrate, to transfer the uneven pattern onto the resist layer.

This method can be performed by the following procedure. First, after forming a silicon oxide film on a substrate surface, the EB lithography method is used to form a prescribed uneven pattern in the silicon oxide film, to prepare a mold. In addition, a stacked member, comprising a film of polymethyl methacrylate (PMMA) or another resin formed on a substrate surface by spin coating or another method, is prepared separately. Next, the resin film is softened at a temperature at or above the glass transition temperature (Tg) of the resin film (for PMMA, with Tg=105° C., 200° C.), and the mold is pressed against the resin film under a pressure of 10 MPa. This resin film is cooled to a temperature lower than the temperature Tg, after which the mold is released from the resin film. In this way, an uneven pattern is formed in the resin film on the substrate. The above-described method is generally referred to as thermal nanoimprinting.

Further, in recent years a method has been developed in which a quartz glass mold and a UV-hardening resist film are used, and instead of applying a thermal cycle, irradiation with UV light is performed. This method is generally referred to as UV nanoimprinting.

By means of the various nanoimprinting methods described above, after forming an uneven pattern in a resin film on a substrate, normally an etching process or other method is used to complete the device (discrete track media or similar, or semiconductor device or similar).

As an example of discrete track media and similar, when forming a magnetic layer comprised by magnetic recording media (and hereafter also simply called a “magnetic recording layer”), first a film forming the depression portions of a resin film in which an uneven pattern has been formed (hereafter also simply called a “remnant film”) is removed by soft etching. Next, the uneven pattern is used as a mask to perform dry etching of the surface of the magnetic recording layer. In this way, by forming a pattern in the magnetic recording layer, magnetic recording media is obtained.

On the other hand, as an example of a semiconductor device, a resist mask is used with a Si substrate or similar, and by performing etching and/or CVD processing, a semiconductor device is obtained.

As technologies related to molds used in nanoimprinting and methods of forming such molds, for use in the manufacture of various devices, the following have for example been disclosed.

In Japanese Patent Application Laid-open No. 2006-191089, a method is disclosed for the manufacture of a manufacturing template for imprint lithography, which is a process of bringing a first target region of imprintable media on the manufacturing template substrate into contact with a parent template and forming a first imprint in the media, including a process in which the imprint demarcates a portion of the manufacturing template pattern and a process of separating the parent template from the imprinted media; and which is a process of bringing a second target region of the media into contact with the parent template and forming a second imprint in the media, including a process in which the second imprint demarcates another portion of the manufacturing template pattern and a process of separating the parent template from the imprinted media.

In Japanese Patent Application Laid-open No. 2004-299153, a stamper is disclosed having a stamper layer with a fine uneven pattern formed in the surface, and a buffer material arranged on the side on which the uneven pattern of the stamper layer is not formed, and such that the buffer material has different elastic moduli within the plane.

In Japanese Patent Application Laid-open No. 2001-143612, a transfer die is disclosed, in which transfer material is packed into depressions of prescribed shape conforming to the shape to be formed by transfer, this is transferred by pressing against media, and an imprinting layer, formed mainly from resin and having the above depressions, is placed on reinforcing base material; in addition, an expansion/contraction control layer, which controls expansion/contraction of the imprinting layer in horizontal directions, is provided on the reinforcing base material side of the imprinting layer.

In Japanese Patent Application Laid-open No. 2005-286222, a stamper for imprinting is disclosed comprising a holding substrate, a separation film provided on the holding substrate exhibiting separation properties as a result of irradiated energy, and a transfer portion, provided on the separation film, the hardness on the Rockwell scale of which is M80 or higher, and which has an uneven pattern in the surface.

In Japanese Patent Application Laid-open No. 2006-523728, a resin composition for molds used in forming fine patterns is disclosed, comprising an activation energy-hardening urethane oligomer having a reactive group, a monomer having reactive properties with the urethane oligomer, a compound containing silicone or fluorine, and a photoinitiator.

Thus various technologies relating to molds and similar used in nanoimprinting methods have been disclosed; but these technologies have the following problems.

That is, in order to apply the above nanoimprinting methods to discrete track media, patterned media, or semiconductor device manufacturing, uniform patterning of the entire substrate surface of the various media must be performed. That is, the substrate and mold must be brought into close contact, and controlled to nanometer order, over the entirety of the substrate surface.

In the manufacture of magnetic recording media, when the substrate and mold are brought into close contact, if there exists a gap in the plane between the two which is not controlled, the remnant film of the resist becomes thicker according to this gap. For this reason, when resist is used to perform etching, there are concerns that the etching pattern may be uneven, and that variations in the depth thereof may occur.

Next, in the stamper disclosed in Japanese Patent Application Laid-open No. 2004-299153, as described above, buffer material having an elasticity distribution is formed on the face on the side of the stamper layer on which an uneven pattern is not formed (the rear face). The purpose of formation of this buffer material is to realize the precise transfer of the protruding portions of the stamper surface, without being affected by undulations in the substrate.

However, precise transfer can be realized even in portions with different distributions of protruding portions in the stamper surface, even without forming buffer material on the rear face of the stamper layer, if the fluidity of the resist resin forming the pattern is raised.

Further, it is difficult to accurately form members with different elastic moduli (that is, members with different physical properties) on the rear face of the stamper layer.

Moreover, due to differences in the thermal expansion coefficient of the stamper layer and the pattern layer comprised by a fine structure, and/or differences in curing shrinkage rates, there are concerns that warping and/or undulations may occur in the substrate as a whole. For this reason, it is difficult to realize precise transfer at a face the normal to which is the stamper pressing direction, under conditions in which this warping or similar occurs.

In addition, the stamper may be deformed at this face due to the load applied to the stamper during nanoimprinting. Hence it is difficult to control expansion/contract of the stamper overall in the normal direction to the face.

As described above, the transfer die of Japanese Patent Application Laid-open No. 2001-143612 comprises an expansion/contraction control layer which controls expansion/contraction in planar directions, used in plasma display panels, and an elastic layer to absorb irregularity in thickness and similar. According to this reference, at the time of manufacture of a plasma display panel, UV light is passed through from the substrate side of the transfer die. Hence as the layer forming the transfer die, an expansion/contract control layer is formed comprising material, such as metal, which blocks UV light.

However, when manufacturing magnetic recording media, because the substrate comprised by the media is opaque, it is necessary to pass UV light from the side of the mold (equivalent to the above transfer die). For this reason, use of an expansion/contraction control layer which blocks UV light as a constituent element of the mold is undesirable.

Further, in the transfer die of Japanese Patent Application Laid-open No. 2001-143612, an elastic layer is formed between the base material and the expansion/contraction control layer, and one face of the elastic layer is constrained by the base material. Hence because the thickness of the required elastic layer is extremely small relative to the nanoimprinting area, there is little need for the expansion/contraction control layer.

Moreover, in pattern transfer by nanoimprinting, the mold is brought into direct contact with the transfer target. Hence the mold must be easily separated from the transfer target.

As a method of separation, generally a method is used in which a fluoride separation processing film, such as for example DURASURF by Daikin Chemicals Sales Co., Ltd., is deposited on the mold. However, when a method of depositing a fluoride separation processing film is used with a mold to be employed in a nanoimprinting method, the mold durability is inadequate, and degradation of the separation properties during mass production of the transfer target necessitates mold cleaning and repetition of the separation processing film treatment.

On the other hand, a mold is also conceivable in which a polymer with comparatively good separation properties is deposited on the base material serving as the base, and an uneven pattern is formed in this polymer. However, when using such a mold to manufacture the transfer target, the adhesive force between the base material and the above-described polymer is weak, and there are concerns that during nanoimprinting the polymer might be separated from the base material.

Thus there is a need to realize a mold for use in the manufacture of magnetic recording media which enables excellent etching patterns, without the existence of in-plane gaps at the time of close contact with the resist, formed from only appropriate constituent members, and having excellent separation properties.

In recent years, various demands as described above have culminated in the need for development of a mold which enables an excellent S/N ratio for magnetic recording media obtained by pattern transfer in particular.

### SUMMARY OF THE INVENTION

The invention provides a mold which enables the manufacture of magnetic recording media enabling an excellent S/N ratio when transferring a prescribed pattern in particular.

The invention also provides magnetic recording media manufactured using such a mold.

The invention provides a mold for nanoimprinting that includes a base material; an intermediate layer disposed adjacent to the base material; and a pattern formation layer disposed adjacent to the intermediate layer and having a fine uneven pattern in a surface of the pattern formation layer, the intermediate layer comprises an adhesive containing a silicone resin with ultraviolet ray transmission properties, the elastic modulus thereof is smaller than the elastic modulus of the base material, and moreover is smaller than the elastic modulus of the pattern formation layer. A mold for nanoimprinting of this invention can be used in the field of discrete track media and similar, and in the field of semiconductor devices.

In such a mold, it is desirable that the thickness of the intermediate layer be 50 nm or greater; moreover, it is desirable that the thickness of the intermediate layer be 100 times or less than the pattern width of the pattern formation layer. Further, it is desirable that the pattern formation layer comprise a fluoride-containing resin.

The invention includes magnetic recording media manufactured using a mold as described above.

In a mold for nanoimprinting of this invention, an intermediate layer having a prescribed elastic modulus is formed between base material and a pattern formation layer, so that irregularities in the thickness of the protruding portions of the pattern formation layer surface during nanoimprinting, as well as undulations in constituent members of the transfer target, can be absorbed. Hence an excellent S/N ratio can be realized for magnetic recording media obtained by pattern transfer using this mold.

Further, in a mold for nanoimprinting of this invention, when the pattern formation layer comprises a fluoride-containing resin in particular, excellent mold durability can be realized.

Other objects, features, embodiments, advantages, etc. of the invention will become apparent from the following detailed description of the preferred embodiments of the invention.

### BRIEF DESCRIPTION OF THE DRAWINGS

The invention will be described with reference to certain preferred embodiments thereof and the accompanying drawings, wherein:

FIG. 1 is a cross-sectional view showing a mold for nanoimprinting of the invention;

FIG. 2 is a cross-sectional view showing in sequence the processes of a method of manufacture of a mold for nanoimprinting of the invention, in which FIG. 2A shows a process (a) of preparing a base material 12, FIG. 2B shows a process (b) of forming an intermediate layer 14 on the base material 12, FIG. 2C shows a process (c) of forming a resin film 15 on the intermediate layer 14, FIG. 2D shows a process (d) of placing the face of the resin film 15 of the stacked member 20 in opposition to the uneven pattern face of a parent mold 30, arranging and holding the stacked member 20 and parent mold 30 at a fixed interval, FIG. 2E shows a process (d) of pressing the parent mold 30 against the resin film 15 of the stacked member 20 fabricated in (d), transferring the uneven pattern to the surface of the resin film 15, and forming the pattern formation layer 16, and FIG. 2F shows a process (f) of separating the parent mold 30 from the pattern formation layer 16, to obtain an imprinting mold 10;

FIG. 3 is a cross-sectional view showing magnetic recording media of the invention;

FIG. 4 is a cross-sectional view showing in sequence the processes of a method of manufacture of magnetic recording media of the invention, in which FIG. 4A shows is a process (a) of forming in order, on a substrate 42, a magnetic recording layer 43 and resin film 45 to obtain a stacked member 50, FIG. 4B shows a process (b) of opposing the surface of the resin film 45 of the stacked member 50 to the pattern face of the pattern formation layer 16 of the mold 10 of the invention shown in FIG. 1, and arranging and holding the mold 10 and stacked member 50 at a fixed interval, FIG. 4C shows a process (c) of pressing the mold 10 against the resin film 45 of the stacked member 50 fabricated in (b), transferring the uneven pattern to the surface of the resin film 45, and forming the resin film 46 having an uneven pattern, FIG. 4D shows a process (d) of separating the mold 10 from the resin film 46, to obtain a stacked member 60 in which is stacked the resin film 46 having an uneven pattern, FIG. 4E shows a process (e) of removing by etching the remnant film of the depression portions of the resin film 46 shown in (d), exposing the surface of the magnetic recording layer 43, FIG. 4F shows a process (f) of using the resin film 47 having an uneven pattern shown in (e) as a mask to etch the magnetic recording layer 43, to obtain a magnetic recording layer 44 in which a pattern is formed, and FIG. 4G shows a process (g) of removing the resin film 48 shown in (f), to obtain magnetic recording media 40; and,

FIG. 5 is a graph showing the relation between the thickness of the intermediate layer of the mold, and the RRO value of magnetic recording media manufactured using molds with intermediate layers of various thicknesses.

### DESCRIPTION OF THE PREFERRED EMBODIMENTS

### Mold for Nanoimprinting

A mold for nanoimprinting of this invention comprises a base material, an intermediate layer adjacent to the base material, and a pattern formation layer adjacent to the intermediate layer, and having a fine uneven pattern in the surface. Here, the intermediate layer of the mold comprises an adhesive containing a silicone resin with ultraviolet ray transmission properties, and having an elastic modulus which is smaller than the elastic modulus of the base material and smaller than the elastic modulus of the pattern formation layer.

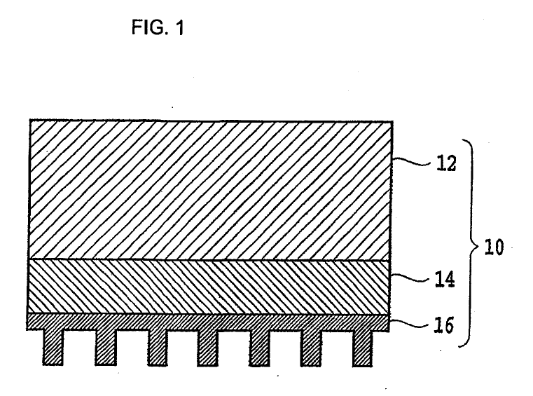

FIG. 1 is a cross-sectional view showing a mold for nanoimprinting of this invention. The nanoimprinting mold 10 shown in this figure comprises a base material 12, intermediate layer 14 positioned below the base material 12, and pattern formation layer 16 positioned below the intermediate layer 14.

Base Material 12

The base material 12 is a constituent element used to hold the overall shape of the mold 10. The base material 12 has an elastic modulus greater than the elastic modulus of the intermediate layer. Also, material which passes ultraviolet rays can be used as the base material 12. Further, it is preferable that the base material 12 comprise a material which is not readily deformed when the mold 10 is pressed against the target object. Various glass base materials which combine these characteristics can be used; in particular, it is preferable that quartz glass, which has high ultraviolet ray transmissivity, be used.

In order to secure adequate precision of the top and bottom faces, it is preferable that the thickness of the base material 12 be 0.3 mm or greater, and still more preferable that the thickness be 0.5 mm or greater. On the other hand, in order to facilitate handling, it is preferable that the thickness of the base material 12 be 10 mm or less, and still more preferable that the base thickness be 1.0 mm or less.

Intermediate Layer 14

The intermediate layer 14 is a constituent element provided to absorb irregularities in the thickness of protruding portions of the pattern formation layer surface during nanoimprinting, as well as undulations in the constituent members of the transfer target. The intermediate layer 14 has an elastic modulus which is smaller than the elastic modulus of the base material 12, and which is smaller than the elastic modulus of the pattern formation layer 16, described below.

Moreover, the intermediate layer 14 employs material which transmits ultraviolet rays. For example, use of a material which transmits 60% or more ultraviolet light at wavelengths of 200 nm to 400 nm is preferable from the standpoint of hardening of an ultraviolet ray-hardening resin, and use of a material which transmits 90% or more ultraviolet light is still more preferable.

Further, use in the intermediate layer 14 of material with high adhesive strength with the base material 12 and with the pattern formation layer 16 is preferable with respect to durability of the mold. For example, an adhesive strength of the intermediate layer 14 with the base material 12 and with the pattern formation layer 16 of 100 kPa or greater is preferable from the standpoint of mold durability, and an adhesive strength of 1 MPa or greater is still more preferable.

As material for the intermediate layer 14 which combines the above characteristics, it is preferable that a silicone resin be used, from the standpoints of the elastic modulus, transmissivity of ultraviolet rays, and adhesive strength. Among such silicone resins, poly dimethyl siloxane (PDMS) is particularly preferable from the standpoints of the elastic modulus, transmissivity of ultraviolet rays, and adhesive strength.

It is preferable that the thickness of the intermediate layer 14 be 50 nm or greater. In this case, irregularities in the thickness of protruding portions of the pattern formation layer surface during nanoimprinting, as well as undulations in the constituent members of the transfer target, can be absorbed by the intermediate layer 14.

Further, the intermediate layer 14 can suppress the effects of expansion and contraction in planar directions. Hence the thickness of the intermediate layer 14 can be set taking into account the pattern widths formed in the surface of the pattern formation layer 16. Here, “pattern widths” means the distances of the intervals between protruding portions formed repeatedly in the uneven pattern, or of the intervals between dots, or of the intervals between holes.

Through earnest studies by the inventors based on this knowledge, it was found that a thickness for the intermediate layer 14 which is 100 times the pattern width of the pattern formation layer 16 or less is appropriate. For example, when the pattern width of the pattern formation layer 16 is 1 μm or less, it is preferable that the thickness of the intermediate layer 14 be 100 μm or less.

According to various knowledge relating to the thickness of the intermediate layer 14 as described above, when a mold 10 of this invention is used to manufacture magnetic recording media, the thickness of the intermediate layer 14 can for example be set as follows. That is, normally the pattern width of the pattern formation layer 16 is from 30 nm to 100 nm in the thinnest portions. Hence the thickness of the intermediate layer 14 can be set to 50 nm to 10 μm.

In particular, when as described above the thickness of the intermediate layer 14 is 10 μm or less, when the mold 10 is pressed against the transfer target, deformation of the intermediate layer 14, which is an elastic layer, can be effectively suppressed. Hence in the plane the normal to which is the pressing direction of the mold 10, there occur no shifts between the transfer target and the mold 10, and the pattern which is to be imparted to the transfer target can be realized with excellent in-plane dimensional precision.

Pattern Formation Layer 16

The pattern formation layer 16 is a constituent element used to impart a prescribed shape to the transfer target. No constraints in particular are imposed on the pattern formation layer 16, so long as the elastic modulus is greater than the elastic modulus of the intermediate layer 14. That is, a polymer material with comparatively high rigidity is used in the pattern formation layer 16. For example, an acrylic resin or an epoxy resin can be used, and a resin with UV hardening properties can be used.

As explained above, the polymer materials which are used in the pattern formation layer 16 comprise acrylic resins and epoxy resins. When using acrylic resins and epoxy resins, a separation film comprising a compound containing fluorine may be formed on the surface of the resin.

Further, it is preferable that the material of the pattern formation layer 16 comprise a fluorine-containing resin. As a fluorine-containing resin, a fluorine-containing UV-hardening resin, or a fluorine-containing thermosetting resin (for example, CYTOP by Asahi Glass Co., Ltd.) can be used.

When a fluorine-containing resin is used as the material of the pattern formation layer 16, there are the following advantages. That is, when forming an uneven pattern in the pattern formation layer 16, the parent mold is pressed against the pattern formation layer 16, and the parent mold is separated from the pattern formation layer 16. At this time, when a fluorine-containing resin is used in the pattern formation layer 16, the parent mold 10 can easily be separated from the pattern formation layer 16. For this reason, there is no need to subject the parent mold 10 to separation treatment, and the number of processes employed in manufacture of the mold 10 can be decreased.

During mass production of a transfer target, normally mold cleaning is necessary according to degradation of the separation properties of the mold. However, when a fluorine-containing resin is used as the material of the pattern formation layer 16, there is no need to consider degradation of the mold separation properties, and so mold cleaning is unnecessary.

A mold 10 for nanoimprinting of this invention, comprising as constituent elements the above-described base material 12, intermediate layer 14, and pattern formation layer 16, can absorb irregularities in the thickness of protruding portions of the pattern formation layer surface during nanoimprinting, as well as undulations in the constituent members of the transfer target, by means of the intermediate layer 14 formed between the base material 12 and the pattern formation layer 16 and having a prescribed elastic modulus. As a result, when using the mold 10 shown in FIG. 1, an excellent S/N ratio is achieved for magnetic recording media obtained by pattern transfer.

Further, when a fluorine-containing resin is included in the pattern formation layer, there is no need to perform mold cleaning according to separation property degradation or to re-form a separation processing film in the mold during mass production of the transfer target. For this reason, excellent mold durability can be achieved.

Method of Manufacture of Mold for Nanoimprinting

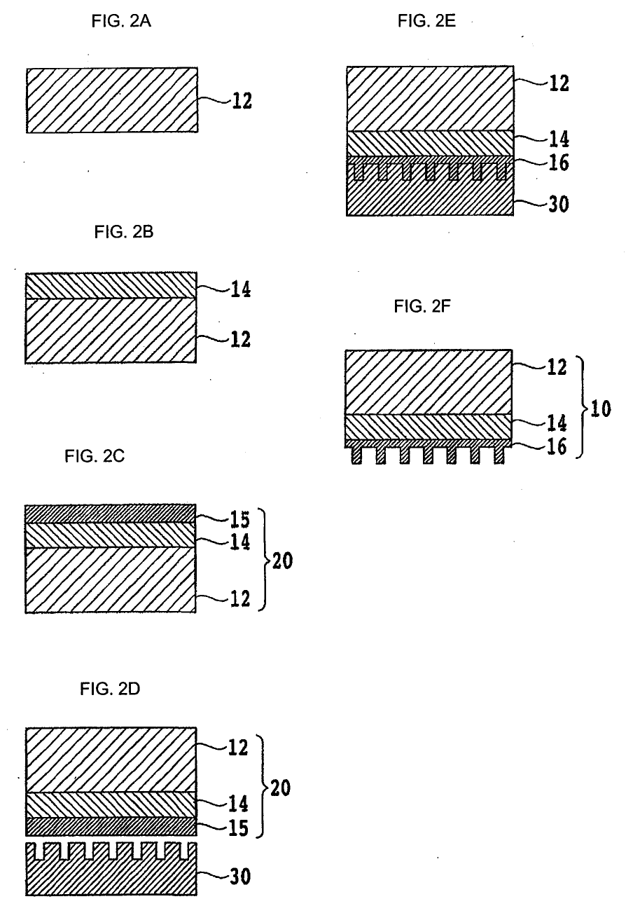

FIG. 2 is a cross-sectional view showing in sequence the processes of a method of manufacture of a mold for nanoimprinting of the invention, in which FIG. 2A shows a process (a) of preparing a base material 12, FIG. 2B shows a process (b) of forming an intermediate layer 14 on the base material 12, FIG. 2C shows a process (c) of forming a resin film 15 on the intermediate layer 14, FIG. 2D shows a process (d) of placing the face of the resin film 15 of the stacked member 20 in opposition to the uneven pattern face of a parent mold 30, arranging and holding the stacked member 20 and parent mold 30 at a fixed interval, FIG. 2E shows a process (e) of pressing the parent mold 30 against the resin film 15 of the stacked member 20 fabricated in (d), transferring the uneven pattern to the surface of the resin film 15, and forming the pattern formation layer 16, and FIG. 2F shows a process (f) of separating the parent mold 30 from the pattern formation layer 16, to obtain an imprinting mold 10. Below, the processes (a) to (f), corresponding respectively to (a) to (f) in FIG. 2, are explained in detail.

Process (a)

In this process, cleaned base material 12 is prepared. As the method of cleaning the base material 12, ultrasonic cleaning in distilled water, or any other well-known cleaning method can be used.

Process (b)

In this process, the intermediate layer 14 is formed on the base material 12. As the method of formation of the intermediate layer 14, a spin coating method, dipping method, spray application method, or any other well-known method can be applied.

For example, when applying a spin coating method, the following procedure can be used. First, the material forming the intermediate layer 14 is dissolved by a solvent to obtain a liquid solution, which is placed on the base material 12. No constraints in particular are placed on the solvent, so long as the solvent is able to dissolve the material forming the intermediate layer 14. Next, the stacked member of the liquid solution placed on the base material 12 is rotated, to form a uniform liquid film on the base material 12. Then, the stacked member in which the liquid film is formed on the base material 12 is heated, to obtain the intermediate layer 14 on the base material 12. No constraints in particular are placed on the heating conditions, so long as the conditions are such that the solvent used is evaporated.

Process (c)

In this process, a resin film 15 is formed on the intermediate layer 14. As the method of formation of the resin film 15, a spin coating method, dipping method, spray application method, or any other well-known method can be applied.

For example, when applying a spin coating method, the following procedure can be used. First, the material forming the resin film 15 is dissolved by a solvent to obtain a liquid solution, which is placed on the intermediate layer 14. No constraints in particular are placed on the solvent, so long as the solvent is able to dissolve the material forming the resin film 15. Next, the stacked member of the intermediate layer 14 and liquid solution placed on the base material 12 is rotated, to form a uniform liquid film on the intermediate layer 14. Then, the stacked member in which the liquid film is formed on the stacked member is heated, to obtain the resin film 15 on the intermediate layer 14. No constraints in particular are placed on the heating conditions, so long as the conditions are such that the solvent used is evaporated.

Process (d)

In this process, the uneven pattern face of the parent mold 30 is placed in opposition to the face of the resin film 15 of the stacked member 20 formed in (c), and the stacked member 20 and parent mold 30 are arranged and held at a fixed interval.

A nanoimprinting device (Toshiba Machine Co., Ltd. model ST-50) (not shown) comprising parallel plates having a fixed vertical interval can be used to arrange the stacked member 20 and parent mold 30 in this way.

As the procedure for fixing the stacked member 20 and parent mold 30 within the device, first the stacked member 20 can be fixed to the upper plate (of quartz glass) of the nanoimprinting device, such that the resin film 15 is the lowermost portion, and then, the parent mold 30 can be fixed to the lower plate of the device, with the pattern face directed upward.

As the parent mold 30, an Ni electrocast mold, Si mold, or quartz glass mold can be used. For obtaining high densities, these molds with fine patterns are preferable.

For example, as an Ni electrocast parent mold 30, a mold can be used which was obtained by forming a pattern in a resist layer placed on a silicon wafer by EB lithography, and then performing Ni electrocasting.

Moreover, from the standpoint of facilitating separation of the parent mold 30 and the stacked member 20, it is preferable that a separation film be formed on the pattern face of the parent mold.

As such a separation film, a compound formable into a film, and having a hydrophobic functional group, can be used. For example, as a compound formable into a film, OPTOOL HD-2101 manufactured by Daikin Industries, Ltd. can be used.

Process (e)

In this process, the parent mold 30 is pressed against the resin film 15 of the stacked member 20 arranged in process (d), to transfer the uneven pattern to the surface of the resin film 15 and form the pattern formation layer 16. Here a case is explained in particular in which a photo- (ultraviolet ray-) hardening material is used in the resin film 15.

First, a nanoimprinting device (not shown) is used to press the parent mold 30 against the stacked member 20 arranged in process (d) under prescribed conditions, to transfer the uneven pattern of the parent mold 30 to the surface of the resin film 15. As the conditions for pressing the parent mold 30 against the resin film 15 of the stacked member 20, for example, conditions can be used under which the pressure within the device is lowered to 100 to 1000 Pa while maintaining a fixed distance between the resin film 15 and the parent mold 30, and the parent mold 30 is pressed against the resin film 15 for from 5 seconds to 1 minute under a pressure of 0.1 to 100 MPa at room temperature (20 to 30° C.).

Next, by irradiating the resin film 15 with ultraviolet rays, while maintaining the state in which the parent mold 30 presses against the resin film 15, the resin film 15 is hardened, to obtain a pattern formation layer 16. As the method of irradiating with ultraviolet rays the resin film 15 to which the uneven pattern of the parent mold 30 has been transferred, for example, a method can be employed in which the resin film 15 is irradiated with ultraviolet rays at a radiation density of 10 to 1000 mJ/cm² via the upper plate of the parallel plates of a nanoimprinting device, in which the resin film 15 of the stacked member 20 has been arranged.

Process (f)

In this process, the parent mold 30 is separated from the pattern formation layer 16 formed in process (e), to obtain a mold 10 for imprinting.

Here, as the conditions for separating the parent mold 30 from the pattern formation layer 16, it is preferable that the separation speed be from 0.01 to 0.1 mm/second, in order to prevent destruction of the protruding portions of the pattern.

Further, a separation film comprising a fluorine-containing compound may be formed on the surface of the pattern formation layer 16 of the mold 10 thus obtained.

Magnetic Recording Media

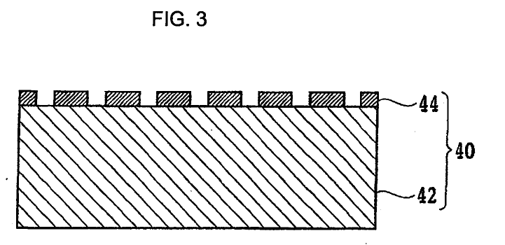

FIG. 3 is a cross-sectional view showing magnetic recording media of this invention. The magnetic recording media 40 shown in the figure comprises a substrate 42, and magnetic recording media 44 which has been patterned on the substrate 42.

Substrate 42

The substrate 42 is a constituent element enabling arrangement thereupon of a magnetic recording layer 44 in a fixed pattern. No constraints in particular are imposed on the substrate 42, so long as the substrate comprises material which is not easily deformed upon pressing a mold of this invention against a transfer target comprising the substrate 42. Specifically, various glass substrates, such as for example reinforced glass, can be used.

It is preferable that the thickness of the substrate 42 be 0.3 mm or greater, in order to secure mechanical strength, and still more preferable that the thickness be 0.5 mm or greater. On the other hand, in order to reduce the thickness and weight of the product, it is preferable that the thickness of the substrate 42 be 1.5 mm or less, and still more preferable that the thickness be 1.0 mm or less.

Magnetic Recording Layer 44

The magnetic recording layer 44 which has been patterned is the constituent element used to write and/or read information.

As the magnetic recording layer 44, for example, a Co-system magnetic alloy, the main component of which is Co, of which representative examples are CoCr, CoNi, CoCrX (where X=Cr is excluded), CoCrPtX (where X=Cr or Pt is excluded), CoSm, CoSmX (where X=Sm is excluded), CoNiX (where X=Ni is excluded), or CoWX (where X=W is excluded) (here X represents one or two or more types of metal selected from among the group comprising Ta, Pt, Au, Ti, V, Cr, Ni, W, La, Ce, Pr, Nd, Pm, Sm, Eu, Li, Si, B, Ca, As, Y, Zr, Nb, Mo, Ru, Rh, Ag, Sb, and Hf or similar), can be used. During use, this can be used independently, or two or more types can be combined and used.

From the standpoint of magnetic characteristics, it is preferable that the thickness of the magnetic recording layer 44 be 10 nm to 100 nm.

Protective Layer and Lubricating Layer

Although not shown in FIG. 3, the magnetic recording media 40 may comprise as constituent elements a protective layer and lubricating layer. Here a protective layer is a layer provided to enhance the wear resistance of the magnetic recording media 40. For this reason, the protective layer is normally formed on the magnetic recording layer 44. And, a lubricating layer is a layer provided to secure lubricating characteristics between the magnetic recording media 40 and the magnetic head. For this reason, the lubricating layer is normally the uppermost layer of the magnetic recording media 40, that is, is formed on the protective layer.

In order to achieve its original objectives, it is generally preferable that a protective layer formed on the magnetic recording layer 44 be formed from material with high mechanical strength. Materials used to form protective layers are generally one or more types selected from a group comprising for example metal oxides of Al, Si, Ti, Cr, Zr, Nb, Mo, Ta, W, or similar (silicon oxide, zirconium oxide, and similar); nitrides of such metals (boron nitride or similar); carbides of such metals (silicon carbide, tungsten carbide, and similar); diamond-like carbon and other carbon forms; and boron nitride or similar. Among the above materials, use of carbon, silicon carbide, tungsten carbide, silicon oxide, zirconium oxide, boron nitride, or a composite of these, is preferable. Further, it is preferable that carbon be used, and in particular that diamond-like carbon and glassy carbon be used.

The thickness of the protective layer can in general be approximately 2 to 5 nm.

Materials normally used in a lubricating layer formed on the protective layer are, for example, a perfluoro polyester, fluoridated alcohol, or fluoridated carboxylic acid.

The thickness of the lubricating layer can be within the range normally used in manufacturing magnetic recording media, such as for example the range 0.5 nm to 2 nm.

Magnetic recording media 40 of this invention, comprising as constituent elements the above-described substrate 42 and magnetic recording layer 44 which has been patterned, has a magnetic recording layer 44 which has been uniformly patterned across the entirety of the substrate 42 in the horizontal direction in FIG. 3, and so can achieve an excellent S/N ratio.

Method of Manufacture of Magnetic Recording Media

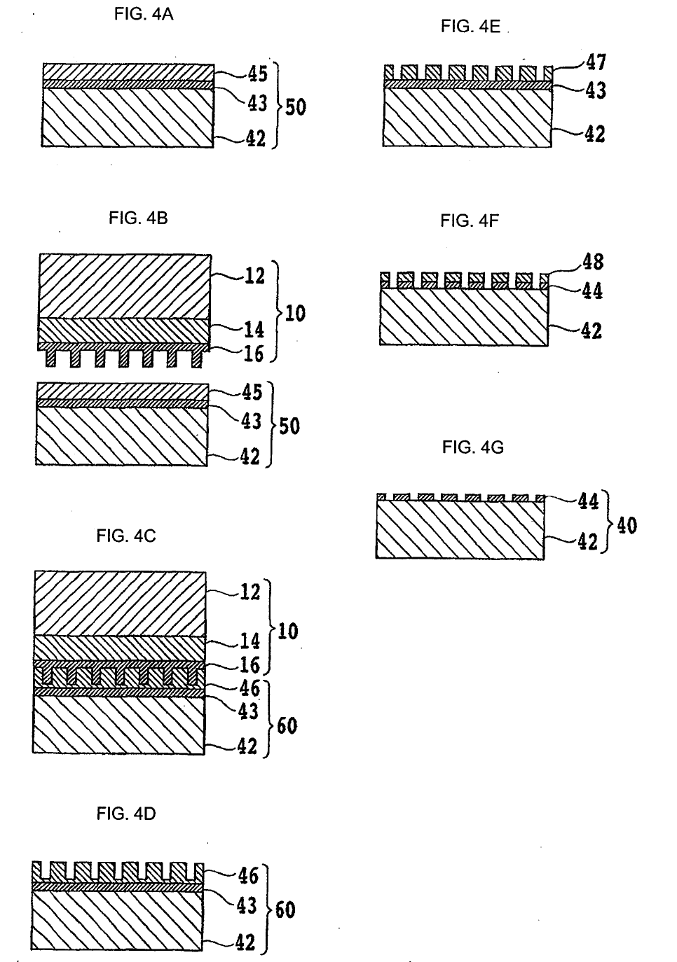

Below, a method of manufacture of magnetic recording media of this invention is explained. FIG. 4 is a cross-sectional view showing in sequence the processes of a method of manufacture of magnetic recording media of the invention, in which FIG. 4A shows a process (a) of forming in order, on a substrate 42, a magnetic recording layer 43 and resin film 45 to obtain a stacked member 50, FIG. 4B shows a process (b) of opposing the surface of the resin film 45 of the stacked member 50 to the pattern face of the pattern formation layer 16 of the mold 10 of the invention shown in FIG. 1, and arranging and holding the mold 10 and stacked member 50 at a fixed interval, FIG. 4C shows a process (c) of pressing the mold 10 against the resin film 45 of the stacked member 50 fabricated in (b), transferring the uneven pattern to the surface of the resin film 45, and forming the resin film 46 having an uneven pattern, FIG. 4D shows a process (d) of separating the mold 10 from the resin film 46, to obtain a stacked member 60 in which is stacked the resin film 46 having an uneven pattern, FIG. 4E shows a process (e) of removing by etching the remnant film of the depression portions of the resin film 46 shown in (d), exposing the surface of the magnetic recording layer 43, FIG. 4F shows a process (f) of using the resin film 47 having an uneven pattern shown in (e) as a mask to etch the magnetic recording layer 43, to obtain a magnetic recording layer 44 in which a pattern is formed, and FIG. 4G shows a process (g) of removing the resin film 48 shown in (f), to obtain magnetic recording media 40. Below, each of the processes (a) to (g), respectively corresponding to (a) to (g) in FIG. 4, is explained in detail.

Process (a)

In this process, the magnetic recording layer 43 and resin film 45 are formed in order on the substrate 42 to obtain the stacked member 50. First, prior to forming the stacked member 50, the substrate 42 is cleaned. As the method of cleaning the substrate 42, ultrasonic cleaning in distilled water, or any other well-known cleaning method can be used.

As the method of forming the magnetic recording layer 43 on the substrate 42, sputtering or any other well-known method can be employed. When employing a sputtering method, the material used in the magnetic recording layer 43 can be used as the constituent component of the target. From the standpoint of magnetic characteristics, it is preferable that the thickness of the magnetic recording layer 43 be from 10 nm to 100 nm.

As the method of forming the resin film 45 on the magnetic recording layer 43, spin coating or any other well-known film deposition method can be employed.

When employing a spin coating method, the following procedure can be used. First, the material forming the resin film 45 is dissolved by a solvent to obtain a liquid solution, which is placed on the magnetic recording layer 43. As the material forming the resin film 45, a photo-hardening material, thermosetting material, or similar can be used. As a material with photo-hardening properties, an ultraviolet ray-hardening resin, such as for example PAK-01 manufactured by Toyo Gosei Co., Ltd., can be used. No constraints in particular are imposed on the solvent, so long as the solvent is capable of dissolving the material forming the resin film 45.

Next, the stacked member with the liquid solution placed on the magnetic recording layer 43 is rotated, to form a uniform liquid film on the magnetic recording layer 43. Then, the stacked member in which the liquid film is formed on the magnetic recording layer 43 is heated, to obtain the resin film 45 on the substrate 42. No constraints in particular are placed on the heating conditions, so long as the conditions are such that the solvent used is evaporated. Considering the groove depth and remnant film thickness of the pattern of the resin film 46, described below, it is desirable that the thickness of the resin film 45 be from 20 nm to 200 nm.

Process (b)

In this process, the pattern face 16 of the mold 10 is placed in opposition to the face of the resin film 45 of the stacked member 50 formed in process (a) within a nanoimprinting device (not shown), and the stacked member 50 and mold 10 are arranged and held at a fixed interval.

A nanoimprinting device comprising parallel plates having a fixed vertical interval (Toshiba Machine Co., Ltd. model ST-50), for example, can be used.

Process (c)

In this process, the mold 10 is pressed against the resin film 45 of the stacked member 50 fabricated in (b), transferring the uneven pattern to the surface of the resin film 45, to form the resin film 46 having the uneven pattern. In particular, here a case in which a material having photo- (ultraviolet ray-) hardening properties is used as the resin film 45.

As conditions for pressing the mold 10 against the resin film 45 of the stacked member 50, the conditions of a pressure within the nanoimprinting device reduced to 100 to 1000 Pa, a pressure of the mold 10 on the resin film 45 of 0.1 to 100 MPa, a temperature of room temperature (20 to 30° C.), and pressing for 5 seconds to 1 minute, can be used. Moreover, it is preferable that pressing of the mold 10 into the resin film 46 be performed at a speed of 0.01 to 1 mm/second, in order to improve the precision of pattern formation.

Next, while maintaining the state in which the mold 10 is pressed against the resin film 45, the resin film 45 is irradiated with ultraviolet rays to harden the resin film 45, to obtain a resin film 46 having the uneven pattern.

As the method of irradiating the resin film 45 with ultraviolet rays, for example a method can be used in which the resin film 45 is irradiated with ultraviolet rays at a radiation density of 10 to 1000 mJ/cm² via the upper plate of parallel plates of the nanoimprinting device in which the mold 10 is arranged.

Process (d)

In this process, the mold 10 is separated from the resin film 46, to obtain a stacked member 60 in which is stacked the resin film 46 having the uneven pattern.

From the standpoint of processing of the magnetic layer by etching in process (f) described below, it is preferable that the depth of the pattern grooves in the resin film 46 be from 10 to 100 nm; and from the standpoint of removal of remnant film by etching in process (e) described below, it is preferable that the thickness of remnant film in the depression portions of the resin film 46 be from 0 to 100 nm.

As conditions for separation of the mold 10 from the resin film 46, it is preferable that the separation speed be from 0.01 to 1 mm/second.

Process (e)

In this process, etching is used to remove the remnant film in the depression portions of the resin film 46 shown in (d), to expose the surface of the magnetic recording layer 43.

As the method used for etching of the remnant film in the depression portions of the resin film 46, dry etching or any other well-known method can be used.

When employing dry etching, etching of the remnant film can be performed using oxygen plasma etching.

When removing the remnant film in the depression portions of the resin film 46 by etching, etching may be used to remove a portion of the protruding portions of the resin film 46. However, it is necessary that the resin film 47 formed by etching of the protruding portions can be used as a mask for the magnetic recording layer 43 in the process (f) described below.

Process (f)

In this process, by using as a mask the resin film 47 having an uneven pattern shown in (e), the magnetic recording layer 43 is etched to obtain a patterned magnetic recording layer 44.

As the method of etching the magnetic recording layer 43, reactive ion etching or any other well-known method can be used. When using reactive ion etching, the magnetic recording layer 43 can be etched using CF₄ gas. When using etching to remove portions of the magnetic recording layer 43, this etching may be used to remove a portion of the protruding portions of the resin film 47.

Process (g)

In this process, the resin film 48 shown in (f) is removed, to obtain magnetic recording media 40, in which a magnetic recording layer 44 having a prescribed pattern is formed on a substrate 42.

As the method of removing the resin film 48, oxygen plasma etching or any other well-known method can be used.

Arbitrary Processes

The method of manufacture of magnetic recording media of this invention described above may further comprise, after process (g) shown in FIG. 4, a process (not shown) of forming a protective layer on the magnetic recording layer 44, and a process (not shown) of forming a lubricating layer on the protective layer.

As the method of forming the protective layer on the magnetic recording layer 44, a sputtering method, a CVD method, or any other well-known method can be used. When using a sputtering method, the material used in the protective layer 43 is used as a constituent component of the target, and the DC magnetron method using argon gas and nitrogen gas can be adopted.

As the method of forming the lubricating layer on the protective layer, a dipping method or any other well-known method can be used.

When employing a dipping method, the lubricating layer can be formed on the protective layer by immersing the magnetic recording media 40 in a dipping layer, and then lifting the substrate face of the magnetic recording media 40 perpendicularly with respect to the liquid face from the dipping layer at from 0.1 to 10 mm/second.

Preferred embodiments will now be described to explain the invention in greater detail, and to demonstrate the advantageous results of the invention.

### Embodiment 1

In this embodiment, the effect on the mold performance of an intermediate layer which has a prescribed elastic modulus relative to each of the elastic moduli of the base material and of the pattern formation layer was studied.

A nanoimprinting mold was obtained by the procedure shown in FIG. 2.

First, as shown in FIG. 2A, polycrystalline glass disc-shape base material 12 was prepared. When preparing the base material 12, ultrasonic cleaning in distilled water was performed to clean the base material 12. As the shape of the base material 12, the outer diameter was 65 mm, the inner diameter was 25 mm, and the thickness was 0.635 mm. The elastic modulus of the base material 12, as measured by the three-point bending test method, was 100 GPa.

Next, as shown in FIG. 2B, the intermediate layer 14 was formed on the base material 12. Specifically, a poly dimethyl siloxane resin (SYLGARD 184 manufactured by Dow Corning Toray Co., Ltd.) was dissolved in ethyl benzene to obtain a liquid solution, and this liquid solution was placed on the base material 12. Next, the stacked member obtained by placing the liquid solution on the base material 12 was subjected to spin coating, to form a uniform liquid film on the base material 12. Then, the stacked member comprising the liquid film formed on the base material 12 was heated for 40 minutes in an oven at 125° C. By this means, a poly dimethyl siloxane resin film of thickness 1 μm was obtained on the base material 12, to form the intermediate layer 14. Upon measuring the elastic modulus of the intermediate layer 14 using a nano-indentation method, the value was 100 MPa or less. The intermediate layer 14 transmitted 70% of ultraviolet light at 364 nm.

Further, as shown in FIG. 2C, a UV-hardening resin film 15 was formed on the intermediate layer 14. Specifically, a liquid solution of a UV-hardening resin (PAK-01, manufactured by Toyo Gosei Co., Ltd.) was placed on the intermediate layer 14, and the stacked member with the liquid solution placed on the base material 12 was subjected to spin coating to form a uniform liquid film on the intermediate layer 14. Further, the stacked member with the liquid film formed on the base material 12 was held for 2 minutes on a hot plate at 80° C. to remove the solvent, forming a resin film 15 of thickness 100 nm on the intermediate layer 14. Upon measuring the elastic modulus of the resin film 15 using a nano-indentation method, the value was 5 GPa.

Next, as shown in FIG. 2D, the uneven pattern face of a parent mold 30 was placed in opposition to the resin film 15 face of the stacked member 20 formed in (c), and the stacked member 20 and parent mold 30 were arranged and held at a fixed interval.

In order to arrange the stacked member 20 and parent mold 30 in this way, a nanoimprinting device (Toshiba Machine Co., Ltd. model ST-50) (not shown), comprising parallel plates positioned with a fixed vertical gap therebetween, was used.

As the procedure for fixing the stacked member 20 and parent mold 30 within the device, first the stacked member 20 was fixed to the upper plate of the nanoimprinting device (made of quartz glass), such that the resin film 15 was lowermost, and then the parent mold 30 was fixed to the lower plate of the device, such that the pattern face was directed upward.

Here, the parent mold 30 was obtained by using EB lithography to form a prescribed pattern on a resist layer arranged on a silicon wafer, followed by Ni electrocasting.

As the shape of the parent mold 30, the outer diameter was 90 mm and the thickness was 300 μm. The data track pattern of the parent mold 30 for data reading and writing comprises protrusion and depression portions in concentric circles, with a pattern width of 90 nm, in which protruding portions of width 60 nm and depression portions of width 30 nm were arranged in alternation, and with a groove depth of 40 nm. The servo information pattern of the parent mold 30, in which were formed holes, dots, or similar as address information, comprises burst portions as principal portions; a burst portion comprises two burst regions, and in each burst region were arranged holes measuring 90 nm tall by 90 nm wide by 40 nm deep at a pitch of 180 nm. Burst regions were configured such that holes were shifted by one-half a period relative to other burst regions.

By means of both these patterns, data track regions comprising protrusion portions and depression portions, and servo information regions, were formed over the entirety from 25 to 63 mm from the center of the pattern face of the parent mold 30. The above data track regions had narrower pattern widths than the servo information regions.

Prior to use, a separation film was formed as explained below on the pattern face of the parent mold 30.

First, the parent mold 30 was immersed for 1 minute in a solution of OPTOOL HD-2101 manufactured by Daikin Industries, Ltd., which was the material comprised by the separation film. Then, the parent mold 30 was slowly raised from the solution, and was left for 12 hours at room temperature. Next the parent mold 30 was immersed in OPTOOL ZV manufactured by Daikin Industries, Ltd., and cleaning was performed by stirring, after which the parent mold 30 was lifted and was finally dried for 10 minutes at room temperature.

Further, as shown in FIG. 2E, the parent mold 30 was pressed against the stacked member 20 arranged in process (d), and the uneven pattern of the parent mold 30 was transferred to the surface of the UV-hardening resin film 15.

First, the pressure within the device was reduced to 1000 Pa while maintaining a constant distance between the resin film 15 and the parent mold 30.

Next, by lowering the upper plate of the device in the vertical direction toward the lower plate, the parent mold was pressed against the resin film 15 at a pressure of 0.2 MPa. While maintaining this state, the resin film 15 was irradiated with UV light at wavelength 364 nm and radiation density 100 mJ/cm² from the upper-plate side of the convex printing device, to harden the resin film 15.

Further, as shown in FIG. 2F, the parent mold 30 was separated from the pattern formation layer 16 formed in process (e), to obtain a mold 10 for nanoimprinting.

In order to separate the parent mold 30 from the pattern formation layer 16, the upper plate of the nanoimprinting device was raised in the vertical direction from the lower plate. After the parent mold 30 was separated from the pattern formation layer 16, the pressure within the nanoimprinting device was returned to atmospheric pressure, and the nanoimprinting mold 10 was removed from within the device.

Although not shown, after process (f) in FIG. 2 the mold 10 was arranged in a sealed box, the pressure within the box was lowered, and by introducing heated and vaporized OPTOOL HD-2101 vapor into the sealed box, a separation film was formed on the surface of the pattern formation layer of the mold 10.

By means of the above processes, a nanoimprinting mold 10 was obtained, in which an intermediate layer 14 of thickness 1 μm and a pattern formation layer 16 were stacked in order on a glass substrate 12 of outer diameter 65 mm, inner diameter 25 mm, and thickness 0.635 mm.

The pattern formed in the pattern formation layer 16 was formed over the entire surface extending in the range of φ from 25 mm to 63 mm from the center of the pattern face of the mold 10. This pattern comprised protrusion portions and depression portions in concentric circles. Further, data track regions and servo information regions were formed on the pattern face for data reading and writing. In the data track regions, the pattern width was 90 nm, in which protruding portions of width 60 nm and depression portions of width 30 nm were arranged in alternation, and with a groove depth of 40 nm. The servo information regions were similar to the servo information regions of the parent mold 30.

The above-described mold 10 was used to manufacture magnetic recording media 40 by the procedure shown in FIG. 4.

First, as shown in FIG. 4A, a magnetic recording layer 43 and resin film 45 were formed in order on a substrate 42, to obtain a stacked member 50.

First, a cleaned substrate 42 was prepared. Ultrasonic cleaning with distilled water was used to clean the substrate 42.

As the substrate 42, a glass substrate with a donut shape, that is, with an outer diameter of 65 mm, inner diameter of 20 mm, and thickness of 0.635 mm, was used.

Next, a sputtering method was used to form the magnetic recording layer 43 on the substrate 42.

Then, a resin film 45 was formed on the magnetic recording layer 43. Specifically, a solution of a UV-hardening resin (PAK-01 manufactured by Toyo Gosei Co., Ltd.) was placed on the magnetic recording layer 43. Next, the stacked member with the liquid placed on the magnetic recording layer 43 was subjected to spin coating, to form a uniform liquid film on the magnetic recording layer 43. The stacked member on which this liquid film was formed was then held for 2 minutes on a hot plate at 80° C., to remove the solvent in the liquid film, and a resin film 45 of thickness 40 nm was formed.

Next, as shown in FIG. 4B, the surface of the resin film 45 of the stacked member 50 fabricated in process (a) was opposed to the patterned face of the pattern formation layer 16 of the mold 10, and the mold 10 and stacked member 50 were arranged and held at a fixed interval.

In order to arrange and hold the mold 10 and stacked member 50 at a fixed interval, a nanoimprinting device (not shown), comprising parallel plates positioned with a fixed vertical gap therebetween, was used.

As the procedure for fixing the stacked member 50 and mold 10 within the device, first the mold 10 was fixed to the upper plate of the nanoimprinting device (made of quartz glass), such that the pattern formation layer was facing downward. Next, the resin film 45 was fixed to the lower plate of the device with the surface directed upward.

Further, as shown in FIG. 4C, the mold 10 was pressed against the resin film 45 of the stacked member 50 fabricated in (a), to transfer the uneven pattern to the surface of the resin film 45, and a resin film 46 having an uneven pattern was formed.

In order to press the mold 10 against the resin film 45 of the stacked member 50, first the pressure within the nanoimprinting device was reduced to 1000 Pa. Next, by lowering the upper plate of the device in the vertical direction toward the lower plate, the mold 10 was pressed against the resin film 45 with a pressure of 0.2 MPa. While maintaining this state, the resin film 45 was irradiated with UV light of wavelength 364 nm at a radiation density of 100 mJ/cm² from the side of the quartz glass upper plate of the convex printing device, to harden the resin film 45.

Further, as shown in FIG. 4D, the mold 10 was separated from the resin film 46 in which the pattern was formed in process (c), to obtain the stacked member 60.

Here, the upper plate of the nanoimprinting device was raised in order to separate the mold 10 from the resin film 46. After the mold 10 was separated from the resin film 46, the pressure within the nanoimprinting device was returned to atmospheric pressure, and the stacked member 60 was removed from within the device. In this way, as shown in FIG. 4D, a stacked member 60, with pattern grooves in the resin film 46 of depth 40 nm, and with remnant film in the depression portions of the resin film 46 of thickness 13 nm, was obtained.

Next, as shown in FIG. 4E, the remnant film in the depression portions of the resin film 46 shown in FIG. 4D was removed by dry etching using oxygen plasma, and the surface of the magnetic recording layer 43 was exposed.

As a result of this etching, the pattern thickness of the resin film 47 was 13 nm.

Further, as shown in FIG. 4F, by using the resin film 47 shown in FIG. 4E as a mask and etching the magnetic recording layer 43, a patterned magnetic recording layer 44 was obtained.

Specifically, the magnetic recording layer 43 was etched within a reactive ion etching (RIE) device, using chlorine gas.

Next, as shown in FIG. 4G, the resin film 48 shown in (f) was removed, and a magnetic recording layer 44 having an uneven pattern was formed on the substrate 42 to obtain magnetic recording media 40. The pattern thickness of magnetic recording media 44 was 10 nm.

Finally, although not shown in FIG. 4, a CVD method was used to form a protective layer on the magnetic recording layer 44, and a dipping method was used to form a lubricating film on the protective layer.

By means of the above processes, magnetic recording media 40 was obtained comprising data track patterns comprising protrusion portions and depression portions in concentric circles with protrusion portion widths of 60 nm and depression portion widths of 30 nm, as well as servo information patterns in a portion thereof, over the entire face of a glass substrate with a donut shape, with an outer diameter of 65 mm, inner diameter of 20 mm.

The usefulness of a mold of this invention was confirmed by measuring magnetic recording signals to evaluate the characteristics of magnetic recording media manufactured using a mold of this invention. Here, the magnetic recording signal measurement quantities were the preamble amplitude value and fringe characteristics.

As a result, magnetic recording media fabricated using a mold of this invention exhibited a satisfactory S/N ratio. Hence it was ascertained that a mold of this invention is useful as a mold for nanoimprinting.

### Embodiment 2

In this embodiment, the effect on the mold performance of the elastic modulus of the intermediate layer relative to the elastic moduli of the base material and of the pattern formation layer was studied.

Specifically, mold performance was studied for a case in which the elastic modulus of the intermediate layer was smaller than the elastic moduli of the base material and of the pattern formation layer, and for a case in which the elastic modulus of the intermediate layer was smaller than the elastic modulus of the base material but was equal to the elastic modulus of the pattern formation layer.

As materials forming the intermediate layer with elastic moduli smaller than the elastic moduli of the base material and of the pattern formation layer, silicon resin with a bending modulus of the elastic modulus of less than 100 MPa (Embodiments 2-1 and 2-2), silicone resin with a bending modulus of the elastic modulus of 470 MPa (Embodiment 2-3), and silicone resin with a bending modulus of the elastic modulus of 1,400 MPa (Embodiment 2-4), were used.

On the other hand, as materials forming the intermediate layer with elastic moduli smaller than the elastic modulus of the base material but equal to the elastic modulus of the pattern formation layer, epoxy resin with a bending modulus of elasticity of 3,000 MPa (Comparative Example 2-1), acrylic resin with a bending modulus of elasticity of 3,100 MPa (Comparative Example 2-2), and acrylic resin with a bending modulus of elasticity of 3,300 MPa (Comparative Example 2-3), were used.

As the material forming the base material, glass base material with a bending modulus of elasticity of 100 GPa was used. As material forming the pattern formation layer, a UV-hardening resin with a bending modulus of elasticity of 5 GPa was used.

As the method of manufacture of each of these molds, the method described in Embodiment 1 (manufacture of a nanoimprinting mold) was employed.

In evaluations of each of the molds obtained in this way, stacked members 60 shown in process (d) of FIG. 4 described in Embodiment 1 (manufacture of magnetic recording media) were obtained using each of the molds, the depths of pattern grooves in the resin films 46 and irregularities in the patterns thereof were measured, and evaluations were performed based on these measurement results.

The depths of pattern grooves in the resin films 46 were measured using an atomic force microscope (AFM). Here, measurements of the depths of pattern grooves were performed 10 times at each of 12 positions on the surfaces of a resin film 46, which each 90° distant in the circumferential direction along an inner circumference (near a radius of 26 mm), an intermediate circumference (near a radius of 44 mm), and an outer circumference (near a radius of 62 mm).

Measurements of irregularities in the patterns formed in the surfaces of resin film 46 were performed using an optical surface inspection and analysis (OSA) device, for the entire surface pattern of a resin film 46. Judgments as to the existence of irregularities in the pattern formed in the surface of a resin film 46 were performed using a Candela 6,100 manufactured by KLA-Tencor.

These measurement results appear in Table 1.

TABLE 1
Resins forming intermediate layers and imprinting results

| | Resin forming intermediate layer | | | | Imprinting result | | |
|---|---|---|---|---|---|---|---|
| | | | Bending | | | | Optical |
| | Resin | Manufacturer/ | modulus of | | Pattern groove depth | | surface |
| | type | model | elasticity | | Average | 3σ | inspection |
| Embodiment | Silicone | Dow | under 100 | MPa | 40 nm | 1.0 nm | no |
| 2-1 | resin | Corning | | | | | irregularities |
| | | Toray, | | | | | |
| | | SYLGARD | | | | | |
| | | 184 | | | | | |
| Embodiment | Silicone | Dow | under 100 | MPa | 40 nm | 1.0 nm | no |
| 2-2 | resin | Corning | | | | | irregularities |
| | | Toray, | | | | | |
| | | JCR6110 | | | | | |
| Embodiment | Silicone | Dow | 470 | MPa | 40 nm | 1.5 nm | no |
| 2-3 | resin | Corning | | | | | irregularities |
| | | Toray, | | | | | |
| | | KER-4000- | | | | | |
| | | UV | | | | | |
| Embodiment | Silicone | Dow | 1,400 | MPa | 40 nm | 2.0 nm | no |
| 2-4 | resin | Corning | | | | | irregularities |
| | | Toray, | | | | | |
| | | SCR-1016 | | | | | |
| Comparative | Epoxy | Nissin | 3,000 | MPa | 35 nm; | 5.0 nm; | pattern |
| Example 2-1 | resin | Resin, | | | includes | includes | unformed in |
| | | CEP | | | portions in | portions in | portions |
| | | | | | which | which | |
| | | | | | pattern is | pattern is | |
| | | | | | unformed | unformed | |
| Comparative | Acrylic | Sumitomo | 3,100 | MPa | 35 nm; | 7.0 nm; | pattern |
| Example 2-2 | resin | Chemical, | | | includes | includes | unformed in |
| | | SUMIPEX | | | portions in | portions in | portions |
| | | | | | which | which | |
| | | | | | pattern is | pattern is | |
| | | | | | unformed | unformed | |
| Comparative | Acrylic | Mitsubishi | 3,300 | MPa | 30 nm; | 10.0 nm; | pattern |
| Example 2-3 | resin | Rayon, | | | includes | includes | unformed in |
| | | ACRYPET | | | portions in | portions in | portions |
| | | | | | which | which | |
| | | | | | pattern is | pattern is | |
| | | | | | unformed | unformed | |

According to Table 1, when a silicone resin with the elastic modulus smaller than those of the base material and pattern formation layer (in Embodiments 2-1 to 2-4) was used as the material forming the intermediate layer, there was no variation in the depth of the grooves in the pattern formed in the surface of the resin film 46, the average groove depth in the pattern was 40 nm, and the standard deviation 3σ was 2.0 nm or less.

Moreover, no irregularities existed in the pattern formed in the surface of the resin film 46. Hence servo regions could be confirmed over the entire range, in the range of φ from 25 mm to 63 mm from the center, of the resin film 46.

Further, magnetic recording media 40 shown in FIG. 4G was manufactured by the method described in Embodiment 1 (manufacture of magnetic recording media), employing a mold 10 using silicone resin as the material forming the intermediate layer.

### Embodiments 2-1 to 2-4

Next, magnetic recording signals of this media were measured, and characteristics of the magnetic recording media were evaluated. Here, the magnetic recording signal measurement conditions and evaluation criteria based on measurement results for the signals were as described in Embodiment 1 (evaluations).

As a result, magnetic recording media fabricated using molds of this invention exhibited satisfactory S/N ratios. Hence it was ascertained that a mold of this invention is useful as a mold for nanoimprinting.

On the other hand, in cases in which an epoxy resin (Comparative Example 2-1) or an acrylic resin (Comparative Examples 2-2 and 2-3) with the elastic modulus equal to that of the pattern formation layer was used as the material forming the intermediate layer, variations occurred in the pattern formed in the surface of the resin film 46, and there were places in which servo regions could not be confirmed.

Upon using AFM to observe places in which servo regions could not be confirmed, it was found that the uneven pattern was not formed in these places.

For this reason, magnetic recording media could not be manufactured from a mold which used as the material forming the intermediate layer a resin with the elastic modulus equal to the elastic modulus of the pattern formation layer.

### Embodiment 3

In this embodiment, the effect of the thickness of the intermediate layer on the mold performance was studied.

First, various molds with different intermediate layer thicknesses were manufactured.

As the method of mold manufacture, the method described in Embodiment 1 (manufacture of nanoimprinting mold) was used. However, as the material forming the intermediate layer, SYLGARD 184 manufactured by Dow Corning Toray, and SCR-1016 manufactured by Dow Corning Toray, were used. The amount of dilution by a solvent to dissolve the resin, and the number of rotations when rotating the base material with the solution of the resin dissolved by the solvent placed thereupon, were adjusted appropriately in order to obtain the intermediate layer thicknesses indicated in Table 2 below.

Next, in order to evaluate each of the molds thus obtained, the molds were used to obtain stacked members 60 comprising resin films 46 in which patterns were formed as shown in process (d) of FIG. 4 by the method described in Embodiment 1 (manufacture of magnetic recording media). Next, by measuring irregularities in the patterns of the resin films 46, the molds were evaluated. Here the method of evaluation of pattern irregularities in resin films 46 was similar to the evaluation method described in Embodiment 2.

Measurements of irregularities in the patterns formed in the surfaces of resin film 46 were performed using an optical surface inspection and analysis (OSA) device, for the entire surface pattern of a resin film 46.

These measurement results appear in Table 2.

TABLE 2
Intermediate layer thickness and imprinting results

| | Intermediate | |
|---|---|---|
| | layer | Imprinting result |
| | thickness | Optical surface inspection |
| Comparative Example 3-1 | no | pattern unformed in portions |
| | intermediate | |
| | layer formed | |
| Comparative Example 3-2 | 10 nm | pattern unformed in portions |
| Comparative Example 3-3 | 20 nm | pattern unformed in portions |
| Embodiment 3-1 | 50 nm | no irregularities |
| Embodiment 3-2 | 100 nm | no irregularities |
| Embodiment 3-3 | 200 nm | no irregularities |
| Embodiment 3-4 | 500 nm | no irregularities |
| Embodiment 3-5 | 1 μm | no irregularities |
| Embodiment 3-6 | 2 μm | no irregularities |
| Embodiment 3-7 | 5 μm | no irregularities |
| Embodiment 3-8 | 10 μm | no irregularities |

From Table 2, it was ascertained that as the thickness of the intermediate layer comprised by a mold for nanoimprinting, a thickness of 50 nm or greater is necessary.

### Embodiment 4

In this embodiment, the effect of the thickness of the intermediate layer relative to the pattern width of the pattern formation layer on the mold performance was studied.

First, molds were manufactured having intermediate layer thicknesses of 100 nm, 200 nm, 500 nm, 990 nm, 1,500 nm, 2,200 nm, 2,500 nm, 4,800 nm, 5,500 nm, 9,900 nm, 12,000 nm, 20,000 nm, and 23,000 nm.

As the method of mold manufacture, the method described in Embodiment 1 (manufacture of nanoimprinting mold) was used. However, as the material forming the intermediate layer, SYLGARD 184 manufactured by Dow Corning Toray, and SCR-1016 manufactured by Dow Corning Toray, were used. The amount of dilution by a solvent to dissolve the resin, and the number of rotations when rotating the base material with the solution of the resin dissolved by the solvent placed thereupon, were adjusted appropriately in order to obtain the intermediate layer thicknesses indicated above.

In order to evaluate each of the molds obtained in this way, the molds were used to obtain magnetic recording media by the method described in Embodiment 1 (manufacture of magnetic recording media), magnetic recording signals for the media were measured, and media characteristics were evaluated. As the magnetic recording signals for measurement, repeatable run-out (hereafter also simply called “RRO”) values were measured. As RRO values, there exist low-order component RRO, for which run-out can be corrected, and high-order component RRO, correction for which is difficult. In this Specification, “low-order” component RRO means RRO up to but not including 9th order, and “high-order” component RRO means RRO of 9th and higher orders. As RRO value measurement conditions, run-out correction was performed for low-order component RRO up to but not including the 9th order, and high-order component RRO for the 9th and higher orders was extracted.

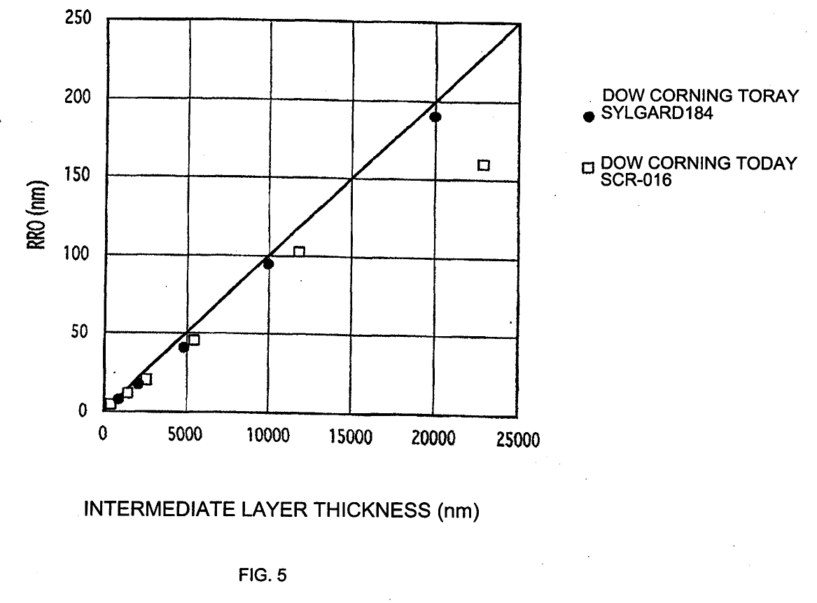

The above measurement results appear in FIG. 5. FIG. 5 is a graph showing the relation between the thickness of the mold intermediate layer, and the RRO value of magnetic recording media fabricated using molds with intermediate layers of various thicknesses.

From FIG. 5, it was ascertained that the thickness of the mold intermediate layer was approximately 100 times the RRO value. From the results shown in FIG. 5 and other data, the inventor further obtained the following knowledge.

In a disk drive which reads data from and writes data to magnetic recording media, a read/write head servo system is installed. Because of this, the head can be accurately maintained over a selected track of the media. In general, the width over which the head is maintained must be 0.1 times or less than the track width of the magnetic recording media. Here, if the RRO value of the magnetic recording media is large, the head maintenance width cannot easily be kept at 0.1 times or less than the track width, so that an excessive load is imposed on the disk drive system, causing worsening of the performance of the disk drive.

Hence the RRO value of magnetic recording media must be within 10 times the head maintenance width. As explained above, the head maintenance width must be kept to 0.1 times the track width of the magnetic recording media or less, so that as a result the RRO value must be made smaller than the track width.

According to FIG. 5, the thickness of the mold intermediate layer is approximately 100 times the RRO value. As explained above, the RRO value must be made smaller than the track width, and so the thickness of the mold intermediate layer must be made 100 times the track width of the magnetic recording media or less.

Here, the track width of the magnetic recording media can be regarded as the pattern width of the mold used in manufacture of the media, that is, as the pattern width of the pattern formation layer.

Hence it can be considered that the thickness of the intermediate layer of the mold used in manufacture of magnetic recording media must be made 100 times the pattern width of the pattern formation layer or less.

The pattern width of magnetic recording media is generally 100 nm or less, and so from results derived from the above consideration, it is preferable that the thickness of the intermediate layer be 10 μm or less.

### Embodiment 5

In this embodiment, the effect of use of a fluorine-containing resin in the pattern formation layer on the mold performance was studied.

First, a mold comprising a fluorine-containing resin in the pattern formation layer was manufactured.

As the method of mold manufacture, the method described in Embodiment 1 (manufacture of nanoimprinting mold) was used. However, in place of PAK-01 manufactured by Toyo Gosei Co., Ltd., which is an acrylic resin not containing fluorine, fluorine-resin containing NIF-A-1, manufactured by Asahi Glass Co., Ltd., was used as the material forming the pattern formation layer. Also, the parent mold was used without forming a separation film on the pattern face. And, no separation film was formed on the pattern face of the nanoimprinting mold.

In order to evaluate the mold obtained in this way, magnetic recording media was manufactured using the mold employing the method described in Embodiment 1 (manufacture of magnetic recording media), magnetic recording signals of the media were measured, and characteristics of the magnetic recording media were evaluated. Here, the magnetic recording signal measurement conditions and evaluation criteria based on measurement results for the signals were as described in Embodiment 1 (evaluations).

As a result, magnetic recording media fabricated using the mold exhibited satisfactory S/N ratios. Hence it was ascertained that the mold is useful as a mold for nanoimprinting.

### Embodiment 6

In this embodiment, the effect of use of a fluorine-containing resin in the material of the pattern formation layer, which is a constituent element of the mold, on the mold durability was studied.

As the mold in which the fluorine-containing resin was used in the material of the pattern formation layer, a mold manufactured in Embodiment 5 (Embodiment 6-1) was used.

When studying mold durability, the durability of a mold of Embodiment 1 (Embodiment 6-2) manufactured without using a fluoride resin in the material of the pattern formation layer was also studied.

Further, durability was also studied for a mold manufactured as in Embodiment 5 above (Embodiment 6-1) and a mold manufactured as in Embodiment 1 (Embodiment 6-2), but without forming an intermediate layer (Comparative Examples 6-1 and 6-2 respectively).

The method of evaluation of durability of the molds was as follows.

First, as shown in process (b) of FIG. 4, the surface of the resin film 45 of the stacked member 50 was opposed to the patterned face of the pattern formation layer of the mold to be evaluated, and the mold 10 and stacked member 50 were arranged and held at a fixed interval. Here the nanoimprinting device used was as described in Embodiment 1.

Next, as shown in process (c) of FIG. 4, the mold was pressed against the resin film 45 of the stacked member 50, and while maintaining this state, the resin film 45 was irradiated with ultraviolet rays to harden the resin film 45, to obtain a resin film 46 having an uneven pattern. Here, the pressing conditions and the hardening conditions were as described in Embodiment 1 (manufacture of magnetic recording media).

Further, as shown in (d) of FIG. 4, the mold was separated from the resin film 46 to obtain a stacked member 60 in which was stacked a resin film 46 having an uneven pattern.

Taking (b) to (d) shown in FIG. 4 to be one imprinting process, this process was repeated a number of times, the occurrence of defects in the mold was observed, and the durability of each mold was evaluated. Here, mold defects included both the case of adherence of a portion of the pattern formation layer to the resin film upon separating the mold from the resin film, causing occurrence of a mold defect, and the case of adhesion of a portion of the resin film to the patterned face of the mold.

The results for durability of the molds appear in Table 3.

TABLE 3
Results of mold durability tests

| | | Embodiment | Embodiment | Comparative | Comparative |
|---|---|---|---|---|---|
| | | 6-1 | 6-2 | Example 6-1 | Example 6-2 |
| Mold type | Pattern | fluorine-containing | acrylic resin | acrylic resin | fluorine-containing |
| | formation | resin | (not | (not | resin |
| | layer | | containing | containing | |
| | | | fluorine) | fluorine) | |
| | Intermediate | silicone resin | silicone resin | none | none |
| | layer | | | | |
| | Elasticity | intermediate | intermediate | — | — |
| | | layer < | layer < | | |
| | | pattern | pattern | | |
| | | formation | formation | | |
| | | layer, base | layer, base | | |
| | | material | material | | |
| Number of | 1 | 0 | 0 | pattern | pattern |
| repetitions of | | | | formation | formation |
| imprinting | | | | layer partially | layer |
| process | | | | detached | completely |
| | | | | | detached |
| | 10 | 0 | 0 | pattern | — |
| | | | | formation | |
| | | | | layer | |
| | | | | completely | |
| | | | | detached | |
| | 100 | 0 | 0 | — | — |
| | 200 | 0 | 2 | — | — |
| | 500 | 0 | 8 | — | — |
| | 1000 | 0 | 42 | — | — |
| | 2000 | 0 | 350 | — | — |
| | 5000 | 0 | >500 | — | — |

*Figures in the table indicate the number of places at which resin film adhered to the patterned face of the mold.

In the case of a mold comprising a fluoride resin as the material of the pattern formation layer, there was no occurrence of mold defects even after 5000 repetitions of the imprinting process. Hence when exerting caution with respect to inclusion of particles and other foreign matter when pressing the mold against the resin film, it is possible to greatly extent the intervals of mold replacement in mass production.

In the case of a mold not comprising a fluoride resin as the material of the mold pattern formation layer as well, no mold defects occurred up to 100 repetitions. However, after 200 repetitions, defects were observed in which a portion of the resin film adhered to the patterned face of the mold in two places. Hence this mold requires replacement after less than 200 repetitions.

On the other hand, in molds in which no intermediate layer was formed (Comparative Examples 6-1 and 6-2), defects occurred after a single imprinting.

Through formation of an intermediate layer having a prescribed elastic modulus between the elastic moduli of the base material and the pattern formation layer, a mold for nanoimprinting of this invention can absorb irregularities in the thickness of the protrusion portions of the mold pattern formation layer surface during nanoimprinting, as well as undulations in the constituent members of the transfer target. As a result, magnetic recording media obtained by pattern transfer using such a mold can achieve an excellent S/N ratio.

In particular, a mold for nanoimprinting of this invention can exhibit excellent durability when the pattern formation layer comprises a fluorine-containing resin. Accordingly, in the field of magnetic recording media and similar applications, in which increasingly high performance is demanded year after year, the invention enables achievement of excellent S/N ratios for magnetic recording media, and moreover for providing molds with excellent durability.

The invention has been described with reference to certain preferred embodiments thereof. It will be understood, however, that modifications and variations are possible within the scope of the appended claims.

This application is based on, and claims priority to, Japanese Patent Application No: 2008-213003, filed on Aug. 21, 2008. The disclosure of the priority application, in its entirety, including the drawings, claims, and the specification thereof, is incorporated herein by reference.

What is claimed is:

1. A mold for nanoimprinting, comprising:
a base material;
an intermediate layer disposed adjacent to the base material; and
a pattern formation layer disposed adjacent to the intermediate layer and having a fine uneven pattern in a surface of the pattern formation layer;
wherein the intermediate layer comprises an adhesive containing a silicone resin with ultraviolet ray transmission properties, and an elastic modulus thereof is smaller than an elastic modulus of the base material and moreover is smaller than an elastic modulus of the pattern formation layer.

2. The mold for nanoimprinting according to claim 1, wherein a thickness of the intermediate layer is 50 nm or greater.

3. The mold for nanoimprinting according to claim 1, wherein a thickness of the intermediate layer is less than or equal to 100 times the pattern width of the pattern formation layer.

4. The mold for nanoimprinting according to claim 2, wherein a thickness of the intermediate layer is less than or equal to 100 times the pattern width of the pattern formation layer.

5. The mold for nanoimprinting according to claim 1, wherein the pattern formation layer comprises a fluorine-containing resin.

6. The mold for nanoimprinting according to claim 2, wherein the pattern formation layer comprises a fluorine-containing resin.

7. The mold for nanoimprinting according to claim 3, wherein the pattern formation layer comprises a fluorine-containing resin.

8. The mold for nanoimprinting according to claim 4, wherein the pattern formation layer comprises a fluorine-containing resin.

9. A method of manufacturing a mold for nanoimprinting, the method comprising:
forming an intermediate layer on a base material;
forming a resin film on the intermediate layer to form a stacked member;
placing a face of the resin film of the stacked member in opposition to an uneven pattern face of a parent mold;
pressing the parent mold against the resin film of the stacked member to transfer the uneven pattern to the face of the resin film to form a pattern formation layer; and
separating the parent mold from the pattern formation layer to obtain the mold;
wherein the intermediate layer comprises an adhesive containing a silicone resin with ultraviolet ray transmission properties, and an elastic modulus thereof is smaller than an elastic modulus of the base material and moreover is smaller than an elastic modulus of the pattern formation layer.

10. The method of manufacturing a mold for nanoimprinting according to claim 9, wherein a thickness of the intermediate layer is 50 nm or greater.

11. The method of manufacturing a mold for nanoimprinting according to claim 9, wherein a thickness of the intermediate layer is less than or equal to 100 times the pattern width of the pattern formation layer.

12. The method of manufacturing a mold for nanoimprinting according to claim 10, wherein a thickness of the intermediate layer is less than or equal to 100 times the pattern width of the pattern formation layer.

13. The method of manufacturing a mold for nanoimprinting according to claim 9, wherein the pattern formation layer comprises a fluorine-containing resin.

14. The method of manufacturing a mold for nanoimprinting according to claim 10, wherein the pattern formation layer comprises a fluorine-containing resin.

15. The method of manufacturing a mold for nanoimprinting according to claim 11, wherein the pattern formation layer comprises a fluorine-containing resin.

16. The method of manufacturing a mold for nanoimprinting according to claim 12, wherein the pattern formation layer comprises a fluorine-containing resin.

17. A method of manufacturing a recording medium comprising:
opposing a surface of a resin film of a stacked member to a pattern face of a pattern formation layer of a mold;
pressing the mold against the resin film of the stacked member to transfer the uneven pattern to the surface of the resin film; and
separating the mold from the resin film;
wherein the mold includes an intermediate layer formed on a base material and a pattern formation layer formed on the intermediate layer; and
wherein the intermediate layer comprises an adhesive containing a silicone resin with ultraviolet ray transmission properties, and an elastic modulus thereof is smaller than an elastic modulus of the base material and moreover is smaller than an elastic modulus of the pattern formation layer.

18. A recording medium manufactured by the process as claimed in claim 17.
